(19) United States
(12) Patent Application Publication
(10) Pub. No.: US 2014/0039647 A1
(43) Pub. Date: Feb. 6, 2014

(54) ANALYZING APPARATUS CONTROL SYSTEM AND PROGRAM FOR THE SAME

(71) Applicant: Nobumitsu Fukushima, Nagaokakyo-shi (JP)

(72) Inventor: Nobumitsu Fukushima, Nagaokakyo-shi (JP)

(21) Appl. No.: 13/952,976

(22) Filed: Jul. 29, 2013

(30) Foreign Application Priority Data
Aug. 1, 2012 (JP) JP2012-170832

(51) Int. Cl. G05B 15/02

(52) U.S. Cl. CPC G05B 15/02
USPC 700/73

(57) ABSTRACT

The present invention relates to an analyzing apparatus control system which can manage the usage degree of consumable parts and provide a user with information on the replacement of the consumable parts, and aims at providing a user with more meaningful information than ever before. The analyzing apparatus control system includes: a usage managing unit 12; an estimated replacement date computation unit 13; and a consumption information display unit 14. The usage managing unit 12 manages a usage degree of consumable parts 4a through 7a of units 4 through 7 that compose an analyzing apparatus 1. The usage degree may be the usage time or the number of times of use up to the present time.

### TECHNICAL FIELD

The present invention relates to an analyzing apparatus control system for controlling an analyzing apparatus such as an infrared spectrophotometer, a visible-ultraviolet spectrophotometer, and a chromatograph. In particular, it relates to an analyzing apparatus control system for controlling an analyzing apparatus having a function of managing information on consumable parts. The present invention also relates to a program for such an analyzing apparatus control system.

### BACKGROUND ART

Generally, the aforementioned types of analyzing apparatuses include consumable parts which should be replaced after a specific duration of use. In the case of a liquid chromatograph system, separation columns and lamps for a detector are consumable parts. These consumable parts are consumed in accordance with the total length of time and the number of uses and hence must be replaced in due course of time. If they are not appropriately managed, the measurement accuracy may be influenced, which might disadvantageously lower the reliability of the measurement result.

In recent years, keeping the analysis environment constant is especially important in order to stabilize the quality of the measurement results. This involves the appropriate replacement of consumable parts. In light of such demands, many analyzing apparatus and analyzing apparatus control systems have a function to inform a user of the usage status and provide a rough guide for the replacement of the consumable parts. For example, Patent Document 1 discloses a system in which an identification module is attached to each of the replaceable parts and the usage status of the parts is managed based on the information signal provided from each of the identification modules. This enables the correct management of the information on the parts even if a part is transferred from one analyzing system to another.

### BACKGROUND ART DOCUMENT

### Patent Document

[Patent Document 1] JP-A 2005-283332

### DISCLOSURE OF THE INVENTION

### Problem to be Solved by the Invention

The system disclosed by Patent Document 1 and other conventional analyzing apparatus control systems having a similar function of managing the consumable parts mainly provide the two following kinds of information on each of the consumable parts.

(1) Current status of use, which is indicated by the number of times of use or the period of time of use of each part up to the present time, is shown in comparison to a reference value for replacement, such as the limit number of times of use or the limit period of time of use.

(2) A warning will also be shown in the case where the number of times of use or the period of time of use is in excess of the reference value for replacement.

Displaying such information can provide the user with the up-to-date replacement information on the currently used consumable parts. However, the user cannot obtain the information on when the consumable parts should be replaced.

### Means for Solving the Problem

To solve the aforementioned problem, the present invention provides an analyzing apparatus control system for controlling an analyzing apparatus including one or a plurality of consumable parts, including:

a usage limit memory unit for storing a predetermined usage limit value for each of the consumable parts;

a usage managing unit for managing a usage degree of each of the consumable parts up to the present time;

an estimated replacement date computation unit for computing an estimated replacement date of each of the consumable parts based on the usage limit value and the usage degree; and

a consumption information display unit for presenting the estimated replacement date for each of the consumable parts in a predetermined display format on a display.

The analyzing apparatus control system according to the present invention can be integrated into the analyzing apparatus itself.

In recent years, analyzing apparatuses have not always been used as stand-alone systems. Instead, in many cases, a control computer (which will be referred to as a “PC” hereinafter) is connected to an analyzing apparatus so as to control the analyzing apparatus, and analyze and manage the data obtained by performing an analysis. Usually, a plurality of different analyzing apparatuses can be connected to one control PC. The present invention can also be applied to such a system.

The present invention also provides a program for an analyzing apparatus control system for controlling an analyzing apparatus including one or a plurality of consumable parts, the program being designed to be executed on a computer capable of accessing a usage limit memory unit for storing a predetermined usage limit value for each of the consumable parts, so as to make the computer function as:

a usage managing unit for managing a usage degree of each of the consumable parts up to the present time;

an estimated replacement date computation unit for computing an estimated replacement date of each of the consumable parts based on the usage limit value and the usage degree; and

a consumption information display unit for presenting the estimated replacement date for each of the consumable parts in a predetermined display format on a display.

### Effects of the Invention

In the analyzing apparatus control system according to the present invention, the estimated replacement date computation unit computes the estimated replacement date for each of the consumable parts, and the estimated replacement dates are presented on the display by the consumption information display unit. Therefore, the user can understand which consumable part should be replaced soon as well as the estimated replacement time for each of the consumable parts. This facilitates the management of the consumable parts, and thus enabling an appropriate managing of the consumable parts. This can ensure a high quality analysis.

### BRIEF DESCRIPTION OF THE DRAWINGS

FIG. 1 shows a schematic configuration diagram of an embodiment of the analyzing apparatus control system according to the present invention.

FIG. 2 is an example of a window shown on a display by a consumption information display unit.

FIG. 3 is another example of a window shown on a display by the consumption information display unit.

FIG. 4 shows a schematic configuration diagram of another embodiment of the analyzing apparatus control system according to the present invention.

### BEST MODES FOR CARRYING OUT THE INVENTION

Hereinafter, an example of the embodiment of the analyzing apparatus control system according to the present invention is described in detail with reference to the figures.

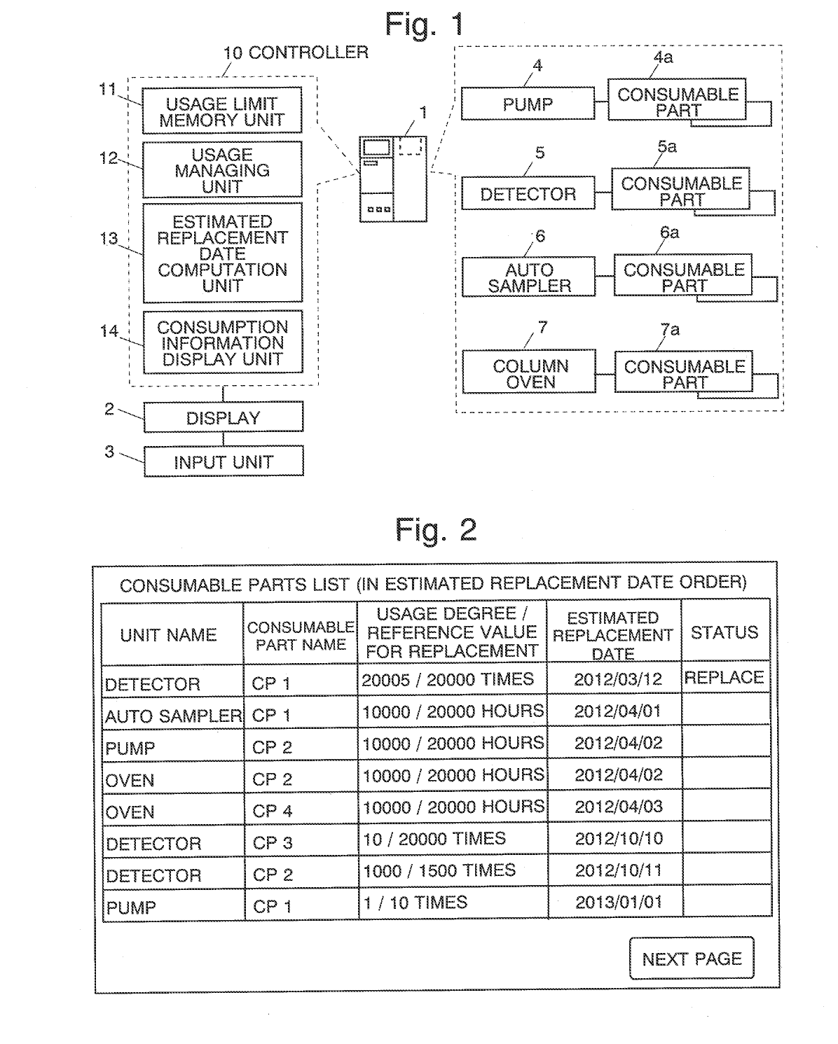

FIG. 1 shows an embodiment of the analyzing apparatus control system according to the present invention. In this embodiment, the analyzing apparatus control system is incorporated as a controller 10 in an analyzing apparatus 1. As shown in FIG. 1, the analyzing apparatus 1 includes a pump 4, a detector 5, an auto sampler 6, a column oven 7, and other units. Each of the units includes consumable parts 4a, . . . , 5a, . . . , 6a, . . . , 7a, . . . . The present analyzing apparatus 1 includes a controller 10, to which a display 2 for displaying various pieces of information and an input unit 3 are connected. The display 2 may be a liquid crystal display (LCD) or another type of display. The input unit 3 may be a keyboard and/or another input interface, such as a touch panel which allows a user to enter a variety of instructions by directly touching the display 2.

The controller 10 includes a usage limit memory unit 11, a usage managing unit 12, an estimated replacement date computation unit 13, and a consumption information display unit 14. The usage limit memory unit 11 is a nonvolatile memory device such as a semiconductor memory and a hard disk. The usage managing unit 12, the estimated replacement date computation unit 13, and the consumption information display unit 14 are realized by executing a dedicated program by means of the cooperation of a central processing unit (CPU) and the memory (neither of which is shown).

In the usage limit memory unit 11, a predetermined usage limit value is stored for each of the consumable parts. The usage limit value may be, for example, the maximum usage time, the maximum usage number, the maximum usage amount, or another value.

The usage managing unit 12 manages the usage degree of each of the consumable parts up to the present time. The managing process includes the operations of storing and updating usage degrees. The usage degree is a value showing the degree of usage of a consumable part and expressed by the period of time of use, the number of times of use, the usage amount, or another value. Every time the analyzing apparatus 1 is used, the usage managing unit 12 updates the usage degrees of the consumable parts 4a through 7a of the units 4 through 7, for example. When a consumable part (e.g. 4a) is replaced, the usage degree is set at an initial value (which is usually “0”).

The estimated replacement date computation unit 13 computes the estimated replacement dates (calendar days) of the consumable parts 4a through 7a based on the present time and date, the usage limit values stored in the usage limit memory unit 11, and the usage degree managed by the usage managing unit 12. The “estimated replacement date” may be just a date, or a date and time (which can be usually indicated by the “hour”).

The estimated replacement date can be expressed not by a calendar day, but by the days (remaining use days) or time (remaining use time) from the present time. The remaining use days and the remaining use time may be computed by any method. For a new consumable part (4a, . . . , 7a) that has never been used before, the remaining use days or the remaining use time may be set at a predetermined default value. The default value may also be preferably used for a consumable part which is not new and yet its usage degree is still below a predetermined valid use lower limit which should be exceeded so as to appropriately compute the average usage degree required for computing the estimated replacement date.

In the case where the usage degree of a consumable part (e.g. 4a) is equal to or higher than the predetermined valid use lower limit, the estimated replacement date may be preferably determined based on the remaining days (or remaining time) obtained by dividing the value acquired by subtracting the usage degree from the usage limit value by the average usage degree per day (or per unit time).

Upon receiving a consumption information display instruction from the input unit 3, for example, the consumption information display unit 14 displays the estimated replacement dates for the consumable parts (e.g. 4a) in a predetermined display format on the display 2.

FIG. 2 is an example of a window shown on the display 2 by the consumption information display unit 14. In this example, the consumable parts (e.g. 4a) included in the analyzing apparatus 1 are listed with their usage degrees and the reference values for replacement (which correspond to the usage limit value in the present invention) in ascending order of the estimated replacement dates which have been computed by the estimated replacement date computation unit 13. In the example of FIG. 2, the “CP 1” (consumable part 5a) of the detector 5 whose usage degree has exceeded the reference value is presented on the top of the list, and the “REPLACE” warning is shown in the status field. Below the “CP 1” (consumable part 5a) of the detector 5, the consumable parts are listed in ascending order of the estimated replacement date.

In the example shown in FIG. 2, all the consumable parts cannot be simultaneously shown in one window. Hence, a “NEXT PAGE” button is provided in the window. When the user presses this button by means of the input unit 3, the information on other consumable parts will be shown. That is, in the example of FIG. 2, the consumption information display unit 14 preferentially presents, on the display 2, the consumable parts (e.g. 4a) whose estimated replacement dates are approaching or have already passed. This enables the user to properly understand the estimated replacement dates of a plurality of consumable parts (e.g. 4a).

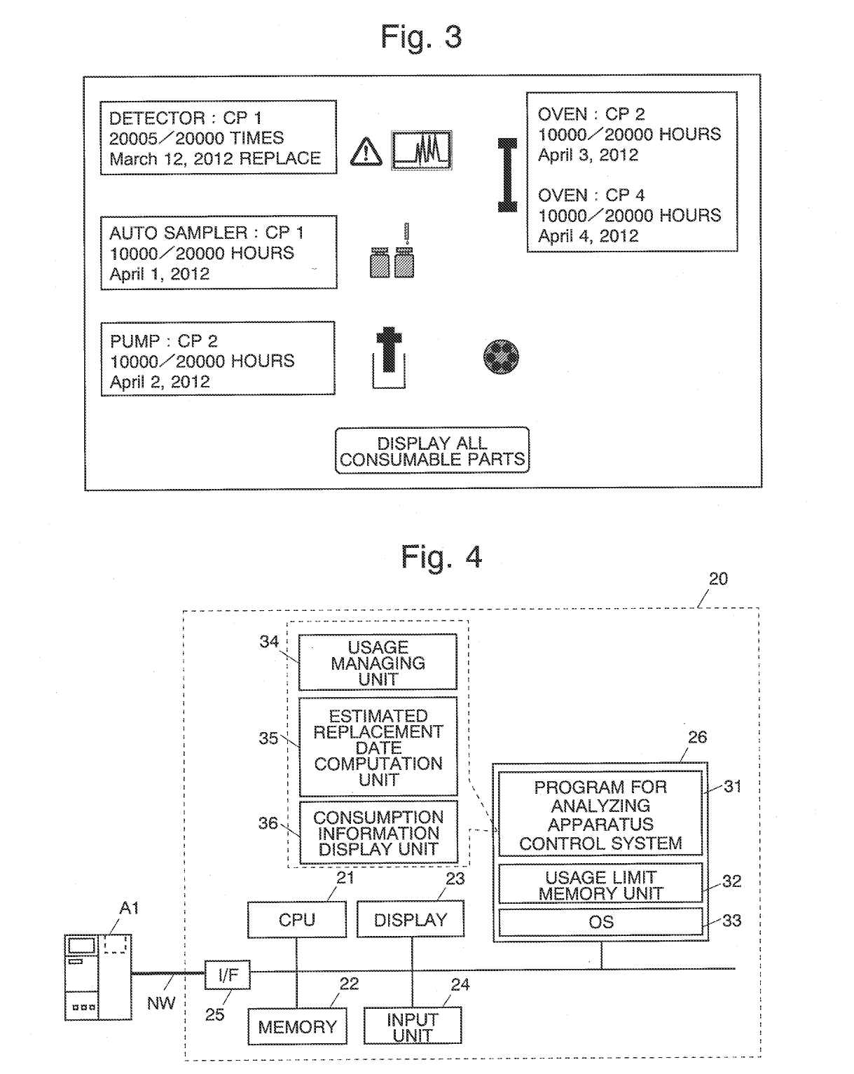

FIG. 3 is another example of a window shown on the display 2 by the consumption information display unit 14. In this window, the information on all the consumable parts (e.g. 4a) included in the analyzing apparatus 1 is not shown, but the information on only one or two consumable parts (e.g. 4a) whose estimated replacement date is approaching is shown for each of the units (the pump 4, the detector 5, the auto sampler 6, and the column oven 7) to which the consumable parts belong. Also in the window of FIG. 3, the letters of “REPLACE” and a warning icon are shown for the “CP 1” (consumable part 5a) of the detector 5 whose usage degree has exceeded the reference value. This enables the user to check each unit separately and have a rough estimation of when the consumable parts should be replaced.

Subsequently, another embodiment of the present invention is described with reference to FIG. 4, which is a schematic configuration diagram. The analyzing apparatus control system 20 according to the present embodiment is connected to an analyzing apparatus A1 via an interface (UF) 25 and via a network (NW). Of course, the analyzing apparatus control system 20 can be connected to a plurality of analyzing apparatuses.

The analyzing apparatus control system 20 shown in FIG. 4 is realized by a computer, and includes a CPU 21, a memory 22, a display 23, and an input unit 24 such as a keyboard and a mouse. The computer includes a storage 26 which is a hard disk or a solid state drive (SSD). A program 31 for an analyzing apparatus control system, a usage limit memory unit 32, and an operating system (OS) 33 are stored in the storage 26. Since the usage limit memory unit 32 is the same as the usage limit memory unit 11 of the analyzing apparatus 1 in the previously described embodiment, the explanation thereof is omitted.

In FIG. 4, a usage managing unit 34, an estimated replacement date computation unit 35, and a consumption information display unit 36 are attached to the program 31 for an analyzing apparatus control system. These units 34, 35, and 36 are implemented as a component when the CPU 21 executes the program 31 for an analyzing apparatus control system. The operations of the usage managing unit 34, the estimated replacement date computation unit 35, and the consumption information display unit 36 are basically the same as the operations of the usage managing unit 12, the estimated replacement date computation unit 13, and the consumption information display unit 14 of the previously described analyzing apparatus 1. Hence, the explanation thereof is omitted.

Also in the analyzing apparatus control system 20, when the program 31 for an analyzing apparatus control system is executed, the consumption information display unit 36 shows a window as shown in FIGS. 2 and 3 on the display 23.

In the analyzing apparatus control system 20, the usage degrees of the consumable parts managed by the usage managing unit 34 may be stored in the storage 26 of the analyzing apparatus control system 20 or on the side of the analyzing apparatus A1.

The analyzing apparatus control system and the program for an analyzing apparatus control system according to the present invention are described by using the embodiments. It should be noted that the embodiments described thus far are merely examples, and it is evident that any appropriate modification or adjustment can be made within the spirit of the present invention.

For example, in the case where a plurality of analyzing apparatuses are connected to the analyzing apparatus control system according to the present invention, the consumption information display unit may show the estimated replacement dates of all the consumable parts included in the plurality of different analyzing apparatuses.

### EXPLANATION OF NUMERALS

1, A1 . . . Analyzing Apparatus
2, 23 . . . Display
3, 24 . . . Input Unit
10 . . . Controller
11, 32 . . . Usage Limit Memory Unit
12, 34 . . . Usage Managing Unit
13, 35 . . . Estimated Replacement Date Computation Unit
14, 36 . . . Consumption Information Display Unit
20 . . . Analyzing Apparatus Control System

1. An analyzing apparatus control system for controlling an analyzing apparatus including one or a plurality of consumable parts, comprising:
a usage limit memory unit for storing a predetermined usage limit value for each of the consumable parts;
a usage managing unit for managing a usage degree of each of the consumable parts up to a present;
an estimated replacement date computation unit for computing an estimated replacement date of each of the consumable parts based on the usage limit value and the usage degree; and
a consumption information display unit for presenting the estimated replacement date for each of the consumable parts in a predetermined display format on a display.

2. The analyzing apparatus control system according to claim 1, wherein:
in a case where a consumable part has never been used before or where a usage degree of the consumable part is below a predetermined valid use lower limit, the estimated replacement date computation unit computes the estimated replacement date based on a predetermined default value, and
in the case where a usage degree of a consumable part is equal to or higher than the valid use lower limit, the estimated replacement date computation unit computes the estimated replacement date based on remaining days obtained by dividing a value acquired by subtracting the usage degree from the usage limit value by an average daily usage degree.

3. The analyzing apparatus control system according to claim 1, wherein:
the consumption information display unit preferentially presents, on the display, the estimated replacement date of a consumable part with a usage degree higher than the usage limit value or with the estimated replacement date being close to a present time.

4. The analyzing apparatus control system according to claim 1, wherein the consumption information display unit lists the estimated replacement dates of the consumable parts separately for each unit composing the analyzing apparatus.

5. A computer readable medium recording a program for an analyzing apparatus control system for controlling an analyzing apparatus including one or a plurality of consumable parts, the program being designed to be executed on a computer capable of accessing a usage limit memory unit for storing a predetermined usage limit value for each of the consumable parts, so as to make the computer function as:
a usage managing unit for managing a usage degree of each of the consumable parts up to a present time;
an estimated replacement date computation unit for computing an estimated replacement date of each of the consumable parts based on the usage limit value and the usage degree; and
a consumption information display unit for presenting the estimated replacement date for each of the consumable parts in a predetermined display format on a display.

6. The computer readable medium recording a program for an analyzing apparatus control system for controlling an analyzing apparatus according to claim 5, wherein:
in a case where a consumable part has never been used before or where a usage degree of the consumable part is below a predetermined valid use lower limit, the estimated replacement date computation unit sets a predetermined default value as the estimated replacement date, and
in the case where a usage degree of a consumable part is equal to or higher than the valid use lower limit, the estimated replacement date computation unit computes the estimated replacement date based on remaining days obtained by dividing a value acquired by subtracting the usage degree from the usage limit value by an average daily usage degree.

7. The computer readable medium recording a program for an analyzing apparatus control system for controlling an analyzing apparatus according to claim 5, wherein:
the consumption information display unit preferentially presents, on the display, the estimated replacement date of a consumable part with a usage degree higher than the usage limit value or with the estimated replacement date being close to a present time.

8. The computer readable medium recording a program for an analyzing apparatus control system according to claim 5, wherein the consumption information display unit lists the estimated replacement dates of the consumable parts separately for each unit composing the analyzing apparatus.

9. The analyzing apparatus control system according to claim 2, wherein:
the consumption information display unit preferentially presents, on the display, the estimated replacement date of a consumable part with a usage degree higher than the usage limit value or with the estimated replacement date being close to a present time.

10. The analyzing apparatus control system according to claim 2, wherein the consumption information display unit lists the estimated replacement dates of the consumable parts separately for each unit composing the analyzing apparatus.

11. The analyzing apparatus control system according to claim 3, wherein the consumption information display unit lists the estimated replacement dates of the consumable parts separately for each unit composing the analyzing apparatus.

12. The analyzing apparatus control system according to claim 9, wherein the consumption information display unit lists the estimated replacement dates of the consumable parts separately for each unit composing the analyzing apparatus.

13. The computer readable medium recording a program for an analyzing apparatus control system for controlling an analyzing apparatus according to claim 6, wherein:
the consumption information display unit preferentially presents, on the display, the estimated replacement date of a consumable part with a usage degree higher than the usage limit value or with the estimated replacement date being close to a present time.

14. The computer readable medium recording a program for an analyzing apparatus control system according to claim 6, wherein the consumption information display unit lists the estimated replacement dates of the consumable parts separately for each unit composing the analyzing apparatus.

15. The computer readable medium recording a program for an analyzing apparatus control system according to claim 7, wherein the consumption information display unit lists the estimated replacement dates of the consumable parts separately for each unit composing the analyzing apparatus.

16. The computer readable medium recording a program for an analyzing apparatus control system according to claim 13, wherein the consumption information display unit lists the estimated replacement dates of the consumable parts separately for each unit composing the analyzing apparatus.
